(19) United States
(12) Patent Application Publication
(10) Pub. No.: US 2022/0414493 A1
(43) Pub. Date: Dec. 29, 2022

(54) COMPUTERIZED SYSTEM AND METHOD FOR GENERATING A MODIFIED PREDICTION MODEL FOR PREDICTING USER ACTIONS AND RECOMMENDING CONTENT

(71) Applicant: VERIZON MEDIA INC., New York, NY (US)

(72) Inventors: Ravi KANT, San Jose, CA (US); Maxim SVIRIDENKO, New York, NY (US); Hirakendu DAS, Jersey City, NJ (US); Balazs SZORENYI, Hoboken, NJ (US); Xiangkun SHEN, Conroe, TX (US); Mikhail KUZNETSOV, Hoboken, NJ (US); Aaron FLORES, Menlo Park, CA (US); Ben SHAHSHAHANI, Menlo Park, CA (US); Balaji Srinivasa Rao PALADUGU, San Jose, CA (US)

(21) Appl. No.: 17/343,119

(22) Filed: Jun. 9, 2021

(51) Int. Cl. G06N 5/04; G06N 20/00; G06N 7/00; H04L 29/08

(52) U.S. Cl. CPC G06N 5/04; G06N 20/00; G06N 7/005; H04L 67/20

(57) ABSTRACT

The disclosed systems and methods provide a novel framework that provides mechanisms for predicting user actions of provided digital content based on an aggregation of user data. Conventional user tracking, and action prediction and recommendation systems have a lifespan that is ending in the short term due to new privacy laws. The disclosed framework enables personalized recommendations to be formulated for specific users based on an imputation from user data aggregated from a plurality of users. While anonymity is maintained, recommendations for predicted actions can be provided to the users and/or the providers of the content. The disclosed framework can scale the aggregated user data using a Naïve Bayes classifier, from which a logistic regression modeling can be performed to determine the predicted recommendation.

This application includes material that is subject to copyright protection. The copyright owner has no objection to the facsimile reproduction by anyone of the patent disclosure, as it appears in the Patent and Trademark Office files or records, but otherwise reserves all copyright rights whatsoever.

### FIELD

The present disclosure relates generally to improving the performance of network-based computerized content hosting and providing devices, systems and/or platforms by modifying the capabilities and providing non-native functionality to such devices, systems and/or platforms through an improved framework that implements a novel prediction algorithm trained on an aggregation of user data for predicting click and conversions of content items and/or providing content recommendations.

### BACKGROUND

Current systems that provide recommendations, advertisements, and/or supplemental content, among other forms of media, rely on detailed activity tracking of individual users. That is, for example, conventional systems rely on specifically labeled data for each individual user as a basis for providing them content, whether it is a predicted ad click or a content recommendation.

### SUMMARY

The present disclosure provides a framework that alleviates shortcomings in the art and provides novel mechanisms for determining and/or predicting user actions, providing recommendations and/or identifying served content based on an aggregation of user data. As discussed herein, disclosed is a novel automated framework comprising a fine-tuned prediction algorithm (e.g., a modified logistic regression algorithm) that utilizes a large sum, or aggregation, of labeled user data. Thus, rather than relying on individual user data to determine or predict conversions and/or user actions, the disclosed framework can leverage an aggregation of data from a plurality of users and impute the content and/or network experience for a specific user. As evidenced from the disclosure herein, this provides a more efficient, light-weight (e.g., scalable to web-scaled sites and pages), deployable framework that can be accurately implemented as users traverse network portals and the pages included therein.

In light of more stringent laws governing online privacy (e.g., General Data Protection Regulation (GDPR), California Consumer Privacy Act (CCPA) and the like), internet platforms and device makers have started to move towards disallowing the tracking of individual users using cookies, device identifiers and other personally identifiable information. This significantly reduces the amount of available information about users. Current approaches crucially rely on and are designed to exploit the ability to track user activity across multiple websites, apps and browser sessions (e.g., the “instance” level). With progressively wider adoption of privacy guidelines, the current prediction systems will be phased out over the course of the next two years.

This, therefore, is leading industries that rely on network traffic and tracked user behaviors (e.g., clicks/conversion) down a path without a current technical solution. Without being able to track individual users' behaviors on and over a network, there is currently no system that provides the granularity for such industries under the changing privacy landscape to determine or predict which actions a user will take.

The disclosed framework, however, provides mechanisms for collecting and aggregating data at a “cohort” level (e.g., a subset of known or detected instances), as discussed below. For example, rather than tracking whether a specific user clicked or did not click on a link, the framework can aggregate a number of clicks from a plurality of users, and leverage this for predicting next actions or recommended content items, as discussed below.

According to some embodiments, with this information, the disclosed framework is configured to perform an attribution step not seen in conventional systems, in that it can use the similarity and dissimilarity between cohorts to optimally infer which characteristics of the cohorts influence the likelihood of the activity (e.g., click/conversion) occurring.

In some embodiments, such probability inference can be based on the maximum-entropy principle. In some embodiments, the probability inference can be determined based on a logistic regression algorithm modified to run a Naive Bayes initializer, as discussed below. In some embodiments, the disclosed attribution functionality enables the framework to extract deep insights into an advertisement's performance and/or an advertiser's value (e.g., a performance metric—for example, a high-click rate among males in the age range of 25-35, located in Sunnyvale, Calif.) that is valuable to ad systems of advertisers.

Thus, the disclosed framework provides a novel, modified logistic regression algorithm that is configured to use data summarized over large groups of users (e.g., cohorts) as the basis for predicting individual user actions and/or which content to provide such users. The disclosed framework executes an algorithm that is the first to produce (e.g., mathematically provable) a single call optimal solution suitable for use in internet-scale ad platforms where the size of the data makes multiple iterations probability determinations expensive and computationally draining. In some embodiments, the logistic regression algorithm is modified via a novel Bayesian reconstruction step that reduces the initialization scale by an order of magnitude (e.g., reduce by a factor of the total quantity—for example, if the total amount of data is 100, then it can be scaled by a factor of 10). This results in a reduction of memory usage and computing resources over conventional systems. As by-product, the algorithm produces an optimal attribution of clicks/conversions to their corresponding impressions.

In accordance with one or more embodiments, the present disclosure provides computerized methods for a novel framework that predicts actions and/or content to be provided or recommended to users based on a modified logistic regression algorithm that leverages an aggregation of user data.

In accordance with one or more embodiments, the present disclosure provides a non-transitory computer-readable storage medium for carrying out the above mentioned technical steps of the framework's functionality. The non-transitory computer-readable storage medium has tangibly stored thereon, or tangibly encoded thereon, computer readable instructions that when executed by a device (e.g., application server, messaging server, email server, ad server, content server and/or client device, and the like) cause at least one processor to perform a method for a novel and improved framework that predicts actions and/or content to be provided or recommended to users based on a modified logistic regression algorithm that leverages an aggregation of user data.

In accordance with one or more embodiments, a system is provided that comprises one or more computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### BRIEF DESCRIPTION OF THE DRAWINGS

The foregoing and other objects, features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a schematic diagram illustrating an example of a network within which the systems and methods disclosed herein could be implemented according to some embodiments of the present disclosure;

FIG. 2 depicts is a schematic diagram illustrating an example of client device in accordance with some embodiments of the present disclosure;

FIG. 3 is a block diagram illustrating components of an exemplary system in accordance with embodiments of the present disclosure;

FIG. 4 is a block diagram illustrating an exemplary data flow in accordance with some embodiments of the present disclosure; and

FIG. 5 is a block diagram illustrating an exemplary data flow in accordance with some embodiments of the present disclosure.

### DESCRIPTION OF EMBODIMENTS

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router (WR) mesh, or 2nd, 3rd, 4^{th} or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or consumer or user) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device an Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

As discussed herein, reference to an “advertisement” should be understood to include, but not be limited to, digital media content embodied as a media item that provides information provided by another user, service, third party, entity, and the like. Such digital ad content can include any type of known or to be known media renderable by a computing device, including, but not limited to, video, text, audio, images, and/or any other type of known or to be known multi-media item or object. In some embodiments, the digital ad content can be formatted as hyperlinked multi-media content that provides deep-linking features and/or capabilities. Therefore, while some content is referred to as an advertisement, it is still a digital media item that is renderable by a computing device, and such digital media item comprises content relaying promotional content provided by a network associated party.

As discussed in more detail below, according to some embodiments, information associated with, derived from, or otherwise identified from, during or as a result of a recommendation or prediction of a user interaction, as discussed herein, can be used for monetization purposes and targeted advertising when providing, delivering or enabling such devices access to content or services over a network. Providing targeted advertising to users associated with such discovered content can lead to an increased click-through rate (CTR) of such ads and/or an increase in the advertiser's return on investment (ROI) for serving such content provided by third parties (e.g., digital advertisement content provided by an advertiser, where the advertiser can be a third party advertiser, or an entity directly associated with or hosting the systems and methods discussed herein).

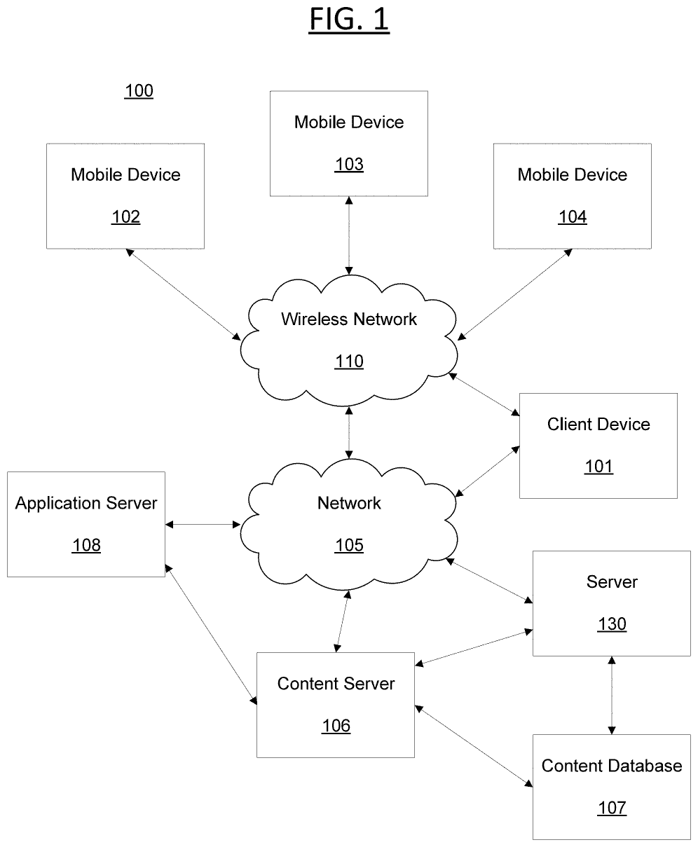

Certain embodiments will now be described in greater detail with reference to the figures. In general, with reference to FIG. 1, a system 100 in accordance with an embodiment of the present disclosure is shown. FIG. 1 shows components of a general environment in which the systems and methods discussed herein may be practiced. Not all the components may be required to practice the disclosure, and variations in the arrangement and type of the components may be made without departing from the spirit or scope of the disclosure. As shown, system 100 of FIG. 1 includes local area networks (“LANs”)/wide area networks (“WANs”)—network 105, wireless network 110, mobile devices (client devices) 102-104 and client device 101. FIG. 1 additionally includes a variety of servers, such as content server 106, application (or “App”) server 108 and third party server 130.

One embodiment of mobile devices 102-104 may include virtually any portable computing device capable of receiving and sending a message over a network, such as network 105, wireless network 110, or the like. Mobile devices 102-104 may also be described generally as client devices that are configured to be portable. Thus, mobile devices 102-104 may include virtually any portable computing device capable of connecting to another computing device and receiving information, as discussed above.

Mobile devices 102-104 also may include at least one client application that is configured to receive content from another computing device. In some embodiments, mobile devices 102-104 may also communicate with non-mobile client devices, such as client device 101, or the like. In one embodiment, such communications may include sending and/or receiving messages, searching for, viewing and/or sharing memes, photographs, digital images, audio clips, video clips, or any of a variety of other forms of communications.

Client devices 101-104 may be capable of sending or receiving signals, such as via a wired or wireless network, or may be capable of processing or storing signals, such as in memory as physical memory states, and may, therefore, operate as a server.

Wireless network 110 is configured to couple mobile devices 102-104 and its components with network 105. Wireless network 110 may include any of a variety of wireless sub-networks that may further overlay stand-alone ad-hoc networks, and the like, to provide an infrastructure-oriented connection for mobile devices 102-104.

Network 105 is configured to couple content server 106, application server 108, or the like, with other computing devices, including, client device 101, and through wireless network 110 to mobile devices 102-104. Network 105 is enabled to employ any form of computer readable media or network for communicating information from one electronic device to another.

The content server 106 may include a device that includes a configuration to provide any type or form of content via a network to another device. Devices that may operate as content server 106 include personal computers, desktop computers, multiprocessor systems, microprocessor-based or programmable consumer electronics, network PCs, servers, and the like. Content server 106 can further provide a variety of services that include, but are not limited to, email services, instant messaging (IM) services, streaming and/or downloading media services, search services, photo services, web services, social networking services, news services, third-party services, audio services, video services, SMS services, MMS services, FTP services, voice over IP (VOIP) services, or the like.

Third party server 130 can comprise a server that stores online advertisements for presentation to users. “Ad serving” refers to methods used to place online advertisements on websites, in applications, or other places where users are more likely to see them, such as during an online session or during computing platform use, for example. Various monetization techniques or models may be used in connection with sponsored advertising, including advertising associated with user data. Such sponsored advertising includes monetization techniques including sponsored search advertising, non-sponsored search advertising, guaranteed and non-guaranteed delivery advertising, ad networks/exchanges, ad targeting, ad serving and ad analytics. Such systems can incorporate near instantaneous auctions of ad placement opportunities during web page creation, with higher quality ad placement opportunities resulting in higher revenues per ad. That is, advertisers will pay higher advertising rates when they believe their ads are being placed in or along with highly relevant content that is being presented to users. Reductions in the time needed to quantify a high quality ad placement offers ad platforms competitive advantages. Thus, higher speeds and more relevant context detection improve these technological fields.

For example, a process of buying or selling online advertisements may involve a number of different entities, including advertisers, publishers, agencies, networks, or developers. To simplify this process, organization systems called “ad exchanges” may associate advertisers or publishers, such as via a platform to facilitate buying or selling of online advertisement inventory from multiple ad networks. “Ad networks” refers to aggregation of ad space supply from publishers, such as for provision en-masse to advertisers. For web portals like Yahoo! ®, advertisements may be displayed on web pages or in apps resulting from a user-defined search based at least in part upon one or more search terms. Advertising may be beneficial to users, advertisers or web portals if displayed advertisements are relevant to interests of one or more users. Thus, a variety of techniques have been developed to infer user interest, user intent or to subsequently target relevant advertising to users.

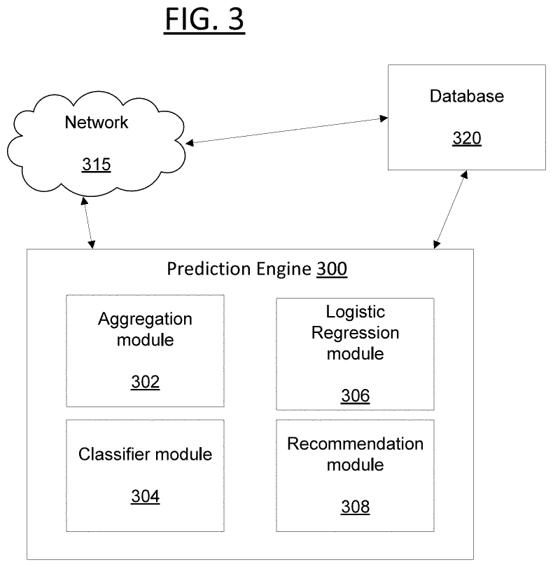

In some embodiments, one approach to presenting targeted advertisements includes employing demographic characteristics (e.g., age, income, gender, occupation, and the like) for predicting user behavior, such as by group. In some embodiments, another approach is provided for via the discussion below in relation to FIGS. 3-5. Advertisements may be presented to users in a targeted audience based at least in part upon predicted user behavior(s).

In some embodiments, during presentation of advertisements, a presentation system may collect descriptive content about types of advertisements presented to users. A broad range of descriptive content may be gathered, including content specific to an advertising presentation system. Advertising analytics gathered may be transmitted to locations remote to an advertising presentation system for storage or for further evaluation. Where advertising analytics transmittal is not immediately available, gathered advertising analytics may be stored by an advertising presentation system until transmittal of those advertising analytics becomes available.

In some embodiments, users are able to access services provided by servers 106, 108 and/or 130. This may include in a non-limiting example, authentication servers, search servers, email servers, social networking services servers, SMS servers, IM servers, MMS servers, exchange servers, photo-sharing services servers, and travel services servers, via the network 105 using their various devices 101-104.

In some embodiments, applications, such as, but not limited to, news applications (e.g., Yahoo! Sports®, ESPN®, Huffington Post®, CNN®, and the like), mail applications (e.g., Yahoo! Mail®, Gmail®, and the like), instant messaging applications, blog, photo or social networking applications (e.g., Facebook®, Twitter®, Instagram®, and the like), search applications (e.g., Yahoo!® Search), and the like, can be hosted by the application server 108, or content server 106 and the like.

Thus, the application server 108, for example, can store various types of applications and application related information including application data and user profile information (e.g., identifying and behavioral information associated with a user). It should also be understood that content server 106 can also store various types of data related to the content and services provided by content server 106 in an associated content database 107, as discussed in more detail below. Embodiments exist where the network 105 is also coupled with/connected to a Trusted Search Server (TSS) which can be utilized to render content in accordance with the embodiments discussed herein. Embodiments exist where the TSS functionality can be embodied within servers 106, 108 and/or 130.

Moreover, although FIG. 1 illustrates servers 106, 108 and 130 as single computing devices, respectively, the disclosure is not so limited. For example, one or more functions of servers 106, 108 and/or 130 may be distributed across one or more distinct computing devices. Moreover, in one embodiment, servers 106, 108 and/or 130 may be integrated into a single computing device, without departing from the scope of the present disclosure.

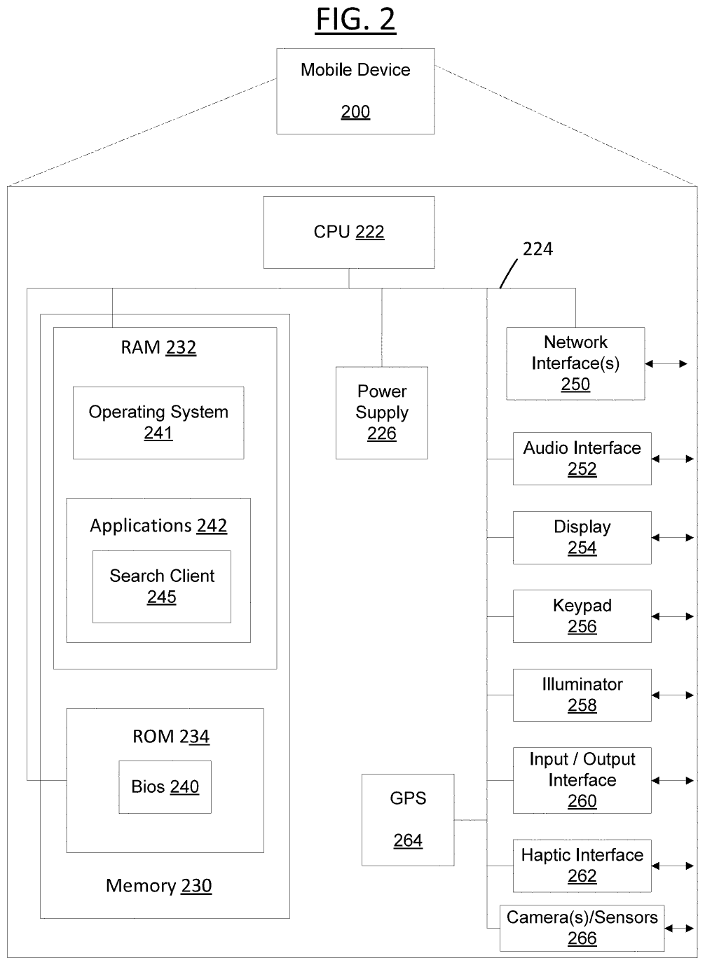

FIG. 2 is a schematic diagram illustrating a client device showing an example embodiment of a client device that may be used within the present disclosure. Client device 200 may include many more or less components than those shown in FIG. 2. However, the components shown are sufficient to disclose an illustrative embodiment for implementing the present disclosure. Client device 200 may represent, for example, client devices discussed above in relation to FIG. 1.

As shown in the figure, Client device 200 includes a processing unit (CPU) 222 in communication with a mass memory 230 via a bus 224. Client device 200 also includes a power supply 226, one or more network interfaces 250, an audio interface 252, a display 254, a keypad 256, an illuminator 258, an input/output interface 260, a haptic interface 262, an optional global positioning systems (GPS) receiver 264 and a camera(s) or other optical, thermal or electromagnetic sensors 266. Device 200 can include one camera/sensor 266, or a plurality of cameras/sensors 266, as understood by those of skill in the art. Power supply 226 provides power to Client device 200.

Client device 200 may optionally communicate with a base station (not shown), or directly with another computing device. Network interface 250 is sometimes known as a transceiver, transceiving device, or network interface card (NIC).

Audio interface 252 can be arranged to produce and receive audio signals such as, for example, the sound of a human voice. Display 254 can, but is not limited to, a include a touch sensitive screen arranged to receive input from an object such as a stylus or a digit from a human hand. Keypad 256 can comprise any input device arranged to receive input from a user. Illuminator 258 may provide a status indication and/or provide light.

Client device 200 also comprises input/output interface 260 for communicating with external devices. Input/output interface 260 can utilize one or more communication technologies, such as USB, infrared, Bluetooth™, or the like. Haptic interface 262 is arranged to provide tactile feedback to a user of the client device.

Optional GPS transceiver 264 can determine the physical coordinates of Client device 200 on the surface of the Earth. In some embodiments however, Client device 200 may through other components, provide other information that may be employed to determine a physical location of the device, including for example, a MAC address, Internet Protocol (IP) address, or the like.

Mass memory 230 includes a RAM 232, a ROM 234, and other storage means. Mass memory 230 stores a basic input/output system (“BIOS”) 240 for controlling low-level operation of Client device 200. The mass memory also stores an operating system 241 for controlling the operation of Client device 200

Memory 230 further includes one or more data stores, which can be utilized by Client device 200 to store, among other things, applications 242 and/or other information or data. For example, data stores may be employed to store information that describes various capabilities of Client device 200. The information may then be provided to another device based on any of a variety of events, including being sent as part of a header (e.g., index file of the HLS stream) during a communication, sent upon request, or the like. At least a portion of the capability information may also be stored on a disk drive or other storage medium (not shown) within Client device 200.

Applications 242 may include computer executable instructions which, when executed by Client device 200, transmit, receive, and/or otherwise process audio, video, images, and enable telecommunication with a server and/or another user of another client device. Applications 242 may further include search client 245 that is configured to send, to receive, and/or to otherwise process a search query and/or search result.

Having described the components of the general architecture employed within the disclosed systems and methods, the components' general operation with respect to the disclosed systems and methods will now be described below.

FIG. 3 is a block diagram illustrating the components for performing the systems and methods discussed herein. FIG. 3 includes prediction engine 300, network 315 and database 320. The prediction engine 300 can be a special purpose machine or processor and could be hosted by a network server (e.g., cloud web services server(s)), messaging server, application server, content server, social networking server, web server, search server, content provider, third party server, user's computing device, and the like, or any combination thereof.

According to some embodiments, prediction engine 300 can be embodied as a stand-alone application that executes on a networking server. In some embodiments, the prediction engine 300 can function as an application installed on the user's device, and in some embodiments, such application can be a web-based application accessed by the user device over a network. In some embodiments, the prediction engine 300 can be configured and/or installed as an augmenting script, program or application (e.g., a plug-in or extension) to another application or portal data structure.

The database 320 can be any type of database or memory, and can be associated with a content server on a network (e.g., content server, a search server or application server) or a user's device (e.g., device 101-104 or device 200 from FIGS. 1-2). Database 320 comprises a dataset of data and metadata associated with local and/or network information related to users, services, applications, content and the like.

In some embodiments, such information can be stored and indexed in the database 320 independently and/or as a linked or associated dataset. An example of this is look-up table (LUT). As discussed above, it should be understood that the data (and metadata) in the database 320 can be any type of information and type, whether known or to be known, without departing from the scope of the present disclosure.

According to some embodiments, database 320 can store data for users, e.g., user data. According to some embodiments, the stored user data can include, but is not limited to, information associated with a user's profile, user interests, user behavioral information, user patterns, user attributes, user preferences or settings, user demographic information, user location information, user biographic information, and the like, or some combination thereof.

In some embodiments, the user data can also include user device information, including, but not limited to, device identifying information, device capability information, voice/data carrier information, Internet Protocol (IP) address, applications installed or capable of being installed or executed on such device, and/or any, or some combination thereof. It should be understood that the data (and metadata) in the database 320 can be any type of information related to a user, content, a device, an application, a service provider, a content provider, whether known or to be known, without departing from the scope of the present disclosure.

According to some embodiments, database 320 can store data and metadata associated with users, searches, actions, clicks, conversions, previous recommendations, messages, images, videos, text, products, items and services from an assortment of media, applications and/or service providers and/or platforms, and the like. Accordingly, any other type of known or to be known attribute or feature associated with a user, message, data item, media item, login, logout, website, application, communication (e.g., a message) and/or its transmission over a network, a user and/or content included therein, or some combination thereof, can be saved as part of the data/metadata in datastore 320.

As discussed above, with reference to FIG. 1, the network 315 can be any type of network such as, but not limited to, a wireless network, a local area network (LAN), wide area network (WAN), the Internet, or a combination thereof. The network 315 facilitates connectivity of the prediction engine 300, and the database of stored resources 320. Indeed, as illustrated in FIG. 3, the prediction engine 300 and database 320 can be directly connected by any known or to be known method of connecting and/or enabling communication between such devices and resources.

The principal processor, server, or combination of devices that comprise hardware programmed in accordance with the special purpose functions herein is referred to for convenience as prediction engine 300, and includes aggregation module 302, classifier module 304, logistic regression module 306 and recommendation module 308. It should be understood that the engine(s) and modules discussed herein are non-exhaustive, as additional or fewer engines and/or modules (or sub-modules) may be applicable to the embodiments of the systems and methods discussed. The operations, configurations and functionalities of each module, and their role within embodiments of the present disclosure will be discussed below.

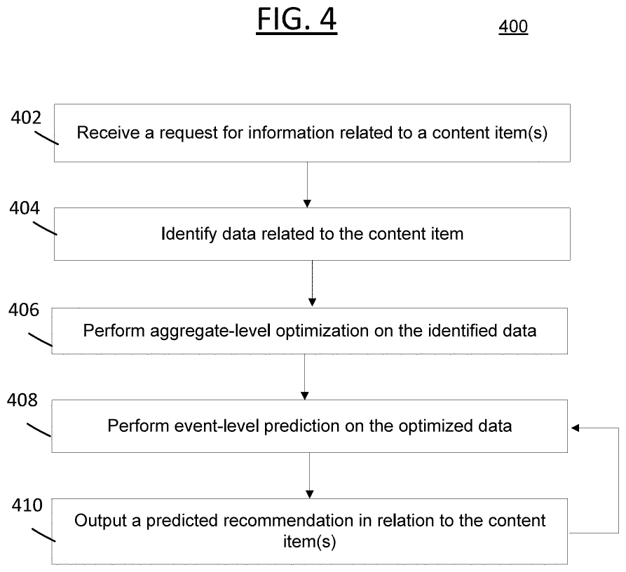

Turning to FIG. 4, Process 400 is disclosed which details non-limiting example embodiments of the disclosed systems and methods. By way of background, traditional label aggregation refers to a setup where labels are unavailable at the instance level and, instead, only aggregations over various subsets of the instances (referred to as cohorts) are available. A classic example is multiple instance learning (MIL), where a cohort (also called “bag” in MIL) is labeled positive if it contains at least one instance with positive label, otherwise it is labeled negative.

The disclosed systems and methods focus on a label aggregation setup referred to as the “label sum problem”, where the cohorts are labeled by nonnegative integers, equaling to the number of positive instances in the given cohort. The feedback for the cohorts can be the label sums instead of the maximal value of the labels. This enables the framework to comply and model closely with the recent technical changes and laws governing programmatic advertising.

Historically, user activities (e.g., clicks and conversions) related to an advertisement (or ad, used interchangeably) could be reported to the advertiser immediately. However, recent requirements to improve data protection and user privacy drastically limit the feedback about conversions, and they are only provided in a mostly anonymized, bundled form. These changes have been pressured by legal regulations (e.g., GDPR, CCPA and the like) and are being applied in basically all major online advertising interfaces (e.g., iOS 14, Safari® Intelligent Tracking Prevention (ITP), Mozilla®, Chrome Privacy Sandbox along with Sandbox and Federated Learning of Cohorts (FLoC) provided by Google®, and the like). Similar practices are applied also in offline conversion tracking, such as the services provided by NCSolutions® or IRI®.

The disclosed systems and methods, as provided for in the non-limiting example embodiments discussed below in relation to Process 400, provide novel imputation mechanisms from aggregations of cohort data. In some embodiments, a portion (or fraction) of label sums from aggregated cohort data (referred to as pseudo-labels) is identified, from which a Naive Bayes initializer is executed that reduces the scale of the “label sum problem” by an order of magnitude. Then, as discussed below, a logistic regression model is fit on the obtained and initialized pseudo-labels. As discussed below, this enables engine 300 to predict conversions with the same or better accuracy as the instance level labels and at an efficiency scale realizable for real-time web-based interactions in accordance with the maximum entropy principle. Moreover, engine 300 is able to provide indications of the efficacy of an advertisement or ad campaign to advertisers based on the predicted conversion data.

According to some embodiments, Steps 402-404 of Process 400 are performed by aggregation module 302 of prediction engine 300; Step 406 is performed by classifier module 304; Step 408 is performed by logistic regression module 306; and Step 410 is performed by recommendation module 308.

Process 400 begins with Step 402 where a request for information related to a content item(s) is received. The request can be related to a set of content items, and/or a platform or provider that hosts and/or provides the content item(s). In some embodiments, the content item can be a digital media item, such as a digital advertisement as discussed herein. In some embodiments, the content item can be an interface object and/or a link (e.g., an item with a deep-linking feature) to an advertisement or other form of promotional or served media.

In some embodiments, the request in Step 402 can be with regard to a request for information related to a CTR, clicks and/or conversions of the content item. In some embodiments, the request can be a request for information indicating a type of action related to the content item that may be performed by a user, a frequency of such action, and/or a result of such action. In some embodiments, the request can be related to determining a value of an impression from which a bid price can be predicted.

In some embodiments, the request can be related to whether the content item can and/or should form the basis of a content recommendation. For example, if the CTR is at or above a threshold value, would a predicted interaction with another similar content item (e.g., of a same context) also satisfy the threshold value. This can drive traffic to network locations and/or drive conversions to additionally provided content items.

In Step 404, data related to the content item is identified. According to some embodiments, as discussed herein, the data can correspond to, but is not limited to, a label, label sum of a collection of data, a feature vector of aggregated user data, and cohort data as discussed herein. Examples of types of user data that can form the labels, feature vectors and/or cohort data are discussed above in relation to FIG. 3.

According to some embodiments, Step 404 involves the identification and collection (and storage) of an aggregation of user data related to the content item. In some embodiments, the user data is aggregated/collected respective to a plurality of platforms and/or resources from which the content item is available for interaction. In some embodiments, the aggregation is based on a time period (e.g., user activity data for a number of days—e.g., 30 days, for example). In some embodiments, the identification of the aggregate user data can be performed by searching for user data related to views, visits and/or interactions with the content item, as identifiable from a database of stored user data (e.g., database 320 as discussed above).

In some embodiments, the user data can correspond to a set or plurality of users, and/or a set or plurality of network resources (or platforms) from which the content item is available for interaction by the users. In some embodiments, the user data can be labeled; and in some embodiments, such labeling can be based on at the cohort level.

According to some embodiments, the aggregated data can be configured as a translated featured vector X, which can have a corresponding label Y, where Y={0, 1} as a set of possible labels. In some embodiments, a distribution of P over Xx Y can be utilized for generating independent and identically distributed (IID) feature vector label pairs (x₁, y₁), (xₙ, yₙ). In some embodiments, the data available for logistic regression module 306 (e.g., the “learner”) can be, but is not limited to, the feature vectors x₁, . . . xₙ, a set of C possible overlapping cohorts where C is a subset of {1, . . . , n} for C∈C, and the number of positive labels for each individual cohort. In some embodiments, the individual labels)), cannot be accessed given the privacy constraints of current systems; therefore, the labels correspond to a cohort (or aggregate).

According to some embodiments, as discussed below, the learner is configured to construct and train a novel logistic regression model based on the available data that maximizes its objectives. For example, in online advertising embodiments, the model can be used for estimating the value of an impression, and this estimate then forms the basis of the bid price. In another example, the model can be trained to predict whether an advertisement will be converted, which can form a basis of estimating a value of an impression.

By way of a non-limiting example, the model can be realized as follows:

f(x\hat{ }*)=E[\tilde{y}|\tilde{x}=x] (Eq. 1),

where x is the input feature vector, and y is the output label, in which the model determines the likelihood that y is positive.

In some embodiments, the model's objective can also reflect how accurately f:X->Y estimates this likelihood for random inputs. In some embodiments, a Kullback-Liebler (KL) divergence can be utilized. For example, a log likelihood can be determined via:

Lₚ(f)=E[\tilde{y} log(f(x))+(1−\tilde{y})log(1−f(\tilde{x}))]=−E[KL(f*(\tilde{x}))∥f(\tilde{x})]−E[Ent(f*(\tilde{x}))] (Eq. 2),

where (\tilde{x}, \tilde{y})˜P, KL(p∥q)=p log (p/q)+(1−p) log ((1−p)/(1−q)), which denotes the KL divergence between two Bernoulli random variables with parameters p and q, respectively, and Ent(p)=p log p−(1−p) log (1−q) denotes the entropy of a Bernoulli random variable with parameter p.

According to some embodiments, as discussed below, engine 300 can use a combination of model-fee and model-based approaches. The model-free approach constructs estimates fᵢ for the individual expectations E|y|xᵢ|, where

1≥fᵢ≥0,i=1, . . . ,n (Eq. 3).

In some embodiments, the constraints set by feedback can be expressed in terms of the model-free estimates:

Σ_{(i∈C)}fᵢ=y_{C}(∀C∈C) (Eq. 4).

In some embodiments, the model-based approach, on the other hand, can involve a logistic-regression model, and in some embodiments, it can use f(x)=1(1+e\hat{ }(−β^{T}x)) for a weight vector β that is trained based on the model-free estimates.

Turning back to Step 404, aggregate user data (e.g., pseudo-labels) is identified. As discussed below, classification of the aggregate data via an aggregate-level optimization (e.g., Naïve Bayes initialization) is used to reduce the scale of the aggregate data (Step 406), from which the combinational model approach is performed (Step 408).

In Step 406, in some embodiments, engine 300 performs an aggregate-level optimization on the data from Step 404. In some embodiments, the operation can be performed via a probabilistic classifier, such as, but not limited to, a Naïve Bayes classifier performing an initialization operation(s). In some embodiments, the Naïve Bayes operation (Step 406) is an initialization operation for the logistic regression model (Step 408), in that the aggregate data is scaled by an order of magnitude. In some embodiments, as discussed herein, cohorts and/or clusters of cohorts can be identified so that relationships between user data and their associate feature vectors (and feature vector and label pairs) can be identified and utilized as input into logistic regression module 306, as discussed below.

According to some embodiments, engine 300 can perform aggregate-level optimization utilizing three aggregate-level objectives. In some embodiments, each objective can be utilized, and in some embodiments, only a portion or combination of a portion of the objectives may be used.

In some embodiments the first objective can be one-sided entropy:

L_{OE}({fᵢ}ⁿᵢ₌₁)=_{Σi=1}ⁿl_{OE}(fᵢ)=Σᵢ₌₁ⁿ−fᵢ log(fᵢ) (Eq. 5),

where l_{OE}=fᵢ log fᵢ.

In some embodiments, the second objective can be Shannon entropy:

L_{SE}({fᵢ}ⁿᵢ₌₁)=Σᵢ₌₁ⁿl_{SE}(fᵢ)=Σᵢ₌₁ⁿ(−fᵢ log(fᵢ)−(1−fᵢ)log(1−fᵢ)) (Eq. 6),

where l_{SE}=fᵢ log fᵢ−(1−f) log (1−fᵢ).

In some embodiments, the third entropy can be Naïve Bayes:

L._{NB}({fᵢ}ⁿᵢ₌₁)=Σᵢ₌₁ⁿl_{NB}^{R(i})(fᵢ)=Σᵢ₌₁ⁿ(−fᵢ log(|R(i)|fᵢ)) (Eq. 7),

where l_{NB}^{R(i)}(fᵢ)=fᵢ log (|R(i)|fᵢ), and where R(i) denotes the refined cohort containing i.

In some embodiments, each objective can be subject to constraints from Eq. 3 and Eq. 4, such that:

[symbol]

n_{R}f_{R}=_{y}(∀C∈ [symbol] ) (Eq. 8), and

1≥f_{R}≥0(∀R∈ [symbol] ) (Eq. 9).

In some embodiments, based on Eq. 8 and Eq. 9, fᵢ=f_{R(i)} for any i=1, . . . , n.

In some embodiments, for Step 406, C can be partitioned into subsets C₁, . . . Cₖ⊆C such that U_{C⊆Ci} C={1, . . . , n} and C∩C′=θ for any i=1, . . . , k and distinct C, C′∈Cᵢ. Then, in some embodiments, L_{NB} under constraints of Eq. 3 and Eq. 4 can be realized as {fᵢ}ⁿᵢ₌₁ with:

$${f}_{i} = \frac{{y}_{x}}{{n}_{R ( i )}} : R ( i ) ⊆ C \frac{{y}_{C}}{{y}_{x}} . \qquad ( Eq . 10 )$$

Thus, in some embodiments, as a result of Step 406, the aggregated data set from Step 404 is initialized so that the cohort grouping has been scaled to represent clusters of specific features (of users and/or the activities represented by the user data). For example, user data related to demographics can be grouped as a cohort group, and user data related to device types can be grouped as a cohort group. This can enable scaling of the data so that a grouping can be analyzed to determine predicted attributes or features of data that indicate types of interactions that correlate to specific cohort groupings.

In Step 408, engine 300 performs event-level prediction on the optimized data from Step 406. In some embodiments, as mentioned above, Step 408 can involve engine 300 implementing a combinational model-free and model-based approach.

In some embodiments, engine 300 executes a logistic regression algorithm on the data scaled as a result of a Naïve Bayes operation performed on the aggregated user/cohort data for the content item. In some embodiments, such execution, which is the performance of Steps 406-408, can be realized through the following Algorithm 1, where NB-LR denotes a Naïve Bayes then Logistic Regression processing of aggregated user data:

Algorithm 1 NB-LR

| | |
|---|---|
| 1: | $Set {f}_{i} = \frac{yx}{{n}_{R ( i )}} {\prod }_{CϵC : R ( i ) ⊆ C} \frac{y c}{yx} .$ |
| 2: | Run logistic regression on the dataset consisting of two |
| | instances of each xᵢ, i = 1, . . . , n: one with positive |
| | label and weight fᵢ, and another one with negative label |
| | and weight (1 − fᵢ). |
| 3: | Denote the obtained parameter vector by β. |
| 4: | Return β |

Where step 1 of Algorithm 1 recites Eq. 10, disclosed above in relation to Step 406. In some embodiments, Algorithm 1 outlined above, therefore, involves identifying a dataset of a set of feature vectors (fᵢ), and executing a Naïve Bayes initiation (Step 1); then, executing a logistic regression on this scaled result (Step 2); where an obtained parameter vector is output that is denoted by β (Step 3), which is then returned and utilized for predicting a next action (Step 4, and Step 410, discussed below). In some embodiments, the denotation operation in Step 3 of Algorithm 1 involves weighting the obtained parameter vector by β. In some embodiments, Algorithm 1 can be executed offline to generate β, which is then utilized for a subsequent time period in an online environment. For example, at the beginning of a day (e.g., 6:00 AM), Algorithm 1 can be executed offline to generate β, and for the remainder of the day's online activity, it can be leveraged as discussed herein.

According to some embodiments, a linear regression model can be embodied as follows:

\hat{L}_{i,l}(f)=|ŷC_{i,l}−Σ_{j∈C}_{_{i,l}}f(xⱼ)|² (Eq. 11),

where i=1, . . . , m, l=1, . . . , t and f:X→[0, 1].

Then, in some embodiments,

$$\hat{f} = arg {min}_{f} \frac{1}{mt} {\sum }_{i = 1}^{m} {\sum }_{l = 1}^{t} {\hat{L}}_{i , l} ( f ) . \qquad ( Eq . 12 )$$

In some embodiments, \hat{f} converges to f*(x)=E[\tilde{y}|\tilde{x}=x] as m approaches infinity, and where f* is defined in Eq. 1. In some embodiments, it can be assumed that f*(x)>0 for any range and for a set of cohorts, whether refined, constant, disjointed or some combination thereof.

According to some embodiments, a number of cohorts with effectively the same distributions may be low (e.g., below a threshold) in certain real-world applications. For example, daily distributions may not evidence a significant change between adjacent days; however, when one day is compared against a day far enough away (e.g., a week, for example), changes in the distributions can be viewed as significant. Thus, in some embodiments, the engine 300 can be trained across cohorts and/or time periods from when cohort data is identified. In some embodiments, therefore, the logistic regression model can be embodied as follows:

f(x)=σ(β^{T}x) where σ(t)=1(1+e⁻¹) (Eq. 13),

where, in some embodiments, is optimized for β:

$${β}^{*} ( {\{ {f}_{i} \}}_{i = 1}^{n} ) = arg {min}_{β} [ {\sum }_{i = 1}^{n} K L ( {f}_{i} ‖ σ ( {β}^{T} {x}_{i} ) ) ] + ρ ( β ) , \qquad ( Eq . 14 )$$

where p is a convex function regularizing the β parameter (e.g., p(β)=λ∥β∥² for a hyperparameter λ>0).

In some embodiments, the logistic regression modeling can maximize a log-likelihood prediction:

$$log ( {\prod }_{i = 1}^{n} {( \frac{1}{1 + {e}^{- {β}^{{T}_{{x}_{i}}}}} )}^{{y}_{i}} {( 1 - \frac{1}{1 + {e}^{- {β}^{{T}_{{x}_{i}}}}} )}^{1 - {y}_{i}} ) = \\ {\sum }_{i = 1}^{n} [ - KL ( \overline{{f}_{i}} ‖ σ ( {β}^{T} {x}_{i} ) - E [ Ent ( {\overline{f}}_{i} ) ] , \qquad ( Eq . 15 )$$

where fᵢ is the empirical label average over the instances with the same feature vector as xᵢ, which is an empirical version of Eq. 2.

In some embodiments, each component of a feature vector may be determined to be associated with a cohort. In some embodiments, k_{c} denotes the index of the component of the feature vector associated with cohort C. Thus, in some embodiments, for any fixed {fᵢ}ⁿᵢ₌₁ satisfying Eq. 3 and Eq. 4, β* ({fᵢ}ⁿᵢ₌₁) from Eq. 14 satisfies:

$${\sum }_{i ∈ C} σ ( {β}^{T} {x}_{i} ) = {y}_{C} - \frac{\partial ρ ( β )}{\partial {β}_{{k}_{C}}} , C ∈ . \qquad ( Eq . 16 )$$

In some embodiments, β* ({fᵢ}ⁿᵢ₌₁) can be computable in polynomial time. In some embodiments, β* ({fᵢ}ⁿᵢ₌₁)=β* ({f′ᵢ}ⁿᵢ₌₁) for any {fᵢ}ⁿᵢ₌₁ and {f′ᵢ}ⁿᵢ₌₁ satisfying Eq. 3 and Eq. 4.

In some embodiments, if p=0, {fᵢ}ⁿᵢ₌₁ can be chosen to be the minimal solution of L_{SE} under constraints of Eq. 3 and 4, where β=β* ({fᵢ}ⁿᵢ₌₁). As a result, Σᵢ₌₁ⁿKL(fᵢ∥σ(β^{T}xᵢ))=0.

According to some embodiments, using a concave function L for regularizing the fᵢ values (e.g., L=L_{SE}), a compositive optimization can be embodied as follows:

$${min}_{β , {\{ {f}_{i} \}}_{i = 1}^{n}} [ {\sum }_{i = 1}^{n} K L ( {f}_{i} ‖ σ ( {β}^{T} {x}_{i} ) ) ] + ρ ( β ) - L ( {\{ {f}_{i} \}}_{i = 1}^{n} ) , \qquad ( Eq . 17 )$$

which can be subject to 1≥fᵢ≥0, i=1, . . . , n, and Σ_{i∈C}fᵢ=y_{C}(∀C∈ [symbol] ). In some embodiments, this can involve not alternating functions, as the B and fᵢ variables are convex objective functions, but not jointly convex.

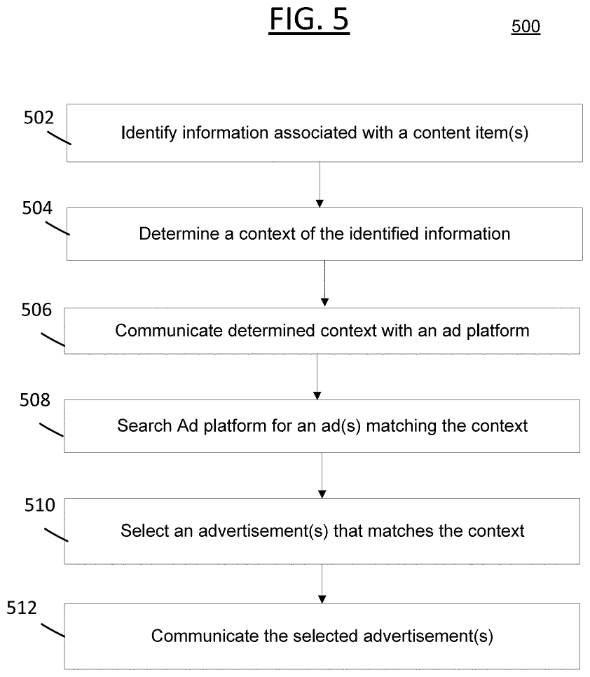

As a result of Step 408, a prediction is generated from the analysis and determination performed by the logistic regression model. As discussed above, a prediction can indicate whether an ad, link or other interactive item on a network will be interacted with and/or converted. In some embodiments, the prediction corresponds to whether the user converts on an impression or an ad. In some embodiments, actions can be recommended to a user (e.g., delete, ignore, or interact based on a prediction of whether the user will have an interest in the content item). In some embodiments, another content item can be recommended. An example of such recommendation is discussed below in relation to FIG. 5.

In Step 410, the predicted recommendation is output. In some embodiments, this can involve sending a third party advertiser information related to predicted results and/or analytics of conversions of their provided content item (e.g., whether predicted conversions are expected and/or at what rate, which is based on the logistic regression modeling discussed above in at least Step 408). As discussed above, this can enable ads and/or other forms of third party content to be quantified so that their efficacy can be evaluated. In some embodiments, the output can provide a recommendation to the advertiser to change their advertisement (e.g., either the content of the ad or the format or location) due to the predicted outcome from Step 408. In some embodiments, where the recommendation is provided content, the output can involve displaying the content and/or sending the content as a recommendation to a user.

In some embodiments, information related to the predicted output provided in Step 410 can be fed back to the logistic regression model (Step 408) for further training, as indicated in the feedback loop of FIG. 4.

FIG. 5 is a workflow process 500 for serving or providing related digital media content based on the information associated with a predicted recommendation, as discussed above in relation to FIGS. 3-4. For example, it is predicted a user will interact with a content item (from FIG. 4), additional third party content can be provided so as to capitalize on a conversion. In some embodiments, the provided content can be associated with or comprising advertisements (e.g., digital advertisement content). Such information can be referred to as “content item information” for reference purposes only.

As discussed above, reference to an “advertisement” should be understood to include, but not be limited to, digital media content that provides information provided by another user, service, third party, entity, and the like. Such digital ad content can include any type of known or to be known media renderable by a computing device, including, but not limited to, video, text, audio, images, and/or any other type of known or to be known multi-media. In some embodiments, the digital ad content can be formatted as hyperlinked multi-media content that provides deep-linking features and/or capabilities. Therefore, while the content is referred as an advertisement, it is still a digital media item that is renderable by a computing device, and such digital media item comprises digital content relaying promotional content provided by a network associated third party.

In Step 502, content item information is identified. This information can be derived, determined, based on or otherwise identified from the steps of Process 40, as discussed above. For example, a content item information can refer to, but is not limited to, cohort data or the recommended/predicted output from Step 410.

In Step 504, a context is determined based on the identified content item information. This context forms a basis for serving content related to the content item.

For example, as discussed herein, if a content item comprises content related to a promotion for 10% off at Starbucks®, then the context of a “purchase discount” can be leveraged for supplementing the coupon with another one for a related product—for example “buy 1 get 1 free.”

In some embodiments, the identification of the context from Step 504 can occur before, during and/or after the analysis detailed above with respect to FIG. 4, or it can be a separate process altogether, or some combination thereof.

In Step 506, the determined context is communicated (or shared) with a content providing platform comprising a server and database (e.g., content server 106 and content database 107, and/or advertisement server 130 and ad database). Upon receipt of the context, the server performs (e.g., is caused to perform as per instructions received from the device executing the engine 300) a search for a relevant digital content within the associated database. The search for the content is based at least on the identified context.

In Step 508, the server searches the database for a digital content item(s) that matches the identified context. In Step 510, a content item is selected (or retrieved) based on the results of Step 508.

In some embodiments, the selected content item can be modified to conform to attributes or capabilities of a device, browser user interface (UI), video, page, interface, platform, application or method upon which a user will be viewing the content item and/or recommendation. In some embodiments, the selected content item is shared or communicated via the application or browser the user is utilizing to consume a webpage. Step 512. In some embodiments, the selected content item is sent directly to a user computing device for display on a device and/or within a user interface (UI) displayed on the device's display (e.g., within the browser window and/or within an inbox of a high-security network property). In some embodiments, the selected content item is displayed within a portion of the interface or within an overlaying or pop-up interface associated with a rendering interface displayed on the device. In some embodiments, the selected content item can augment and/or replace the content item from Step 402 of FIG. 4. In some embodiments, the selected content item can be displayed as part of a coupon/ad clipping, coupon/ad recommendation and/or coupon/ad summarization interface.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
identifying, by a device, user data related to a content item, the user data being an aggregation of data from interactions with the content item by a cohort of users, the user data comprising information related to a label for each interaction;
executing, by the device, a classifier as an initializer on the identified user data;
determining, by the device, based on the execution of the initializer, a set of user data clusters, each cluster corresponding to a feature of a user from the cohort;
executing, by the device, a logistic regression (LR) model on the set of user data clusters; and
determining, by the device, based on the execution of the LR model, a predicted action by a user respective to the content item.

2. The method of claim 1, further comprising:
communicating, over a network, information related to the predicted action to a provider of the content item.

3. The method of claim 1, wherein the classifier operates at least one of a one-sided entropy objective, a Shannon entropy objective and a Naïve Bayes (NB) entropy objective.

4. The method of claim 1, further comprising operating the classifier using a Naïve Bayes (NB) entropy objective, the execution of the NB entropy objective causing the user data to be scaled by an order of magnitude, wherein the LR model is applied to the scaled user data.

5. The method of claim 1, further comprising:
determining, based on the execution of the initializer, a cluster of cohort data, wherein the execution of the LR model is based on the cluster of cohort data.

6. The method of claim 1, wherein each cluster corresponds to a feature of an interaction.

7. The method of claim 1, wherein the user data is formatted as a feature vector.

8. The method of claim 7, wherein the user data comprises a set of pairs of feature vectors and labels.

9. The method of claim 1, further comprising:
receiving a request for information related to the content item, wherein the identification of the user data is based on the reception of the request.

10. The method of claim 9, wherein the request corresponds to a determination of analytics of a performance of the content item.

11. The method of claim 9, wherein the request corresponds to a content recommendation for the user.

12. The method of claim 11, further comprising:
requesting, over the network, third party digital content based information related to the predicted action and the content item;
receiving, over the network, the third party digital content; and
communicating, over the network, the third party digital content to the user.

13. A non-transitory computer-readable storage medium tangibly encoded with computer-executable instructions, that when executed by a processor associated with a device, performs a method comprising:
identifying, by the device, user data related to a content item, the user data being an aggregation of data from interactions with the content item by a cohort of users, the user data comprising information related to a label for each interaction;
executing, by the device, a classifier as an initializer on the identified user data;
determining, by the device, based on the execution of the initializer, a set of user data clusters, each cluster corresponding to a feature of a user from the cohort;
executing, by the device, a logistic regression (LR) model on the set of user data clusters; and
determining, by the device, based on the execution of the LR model, a predicted action by a user respective to the content item.

14. The non-transitory computer-readable storage medium of claim 13, further comprising:
communicating, over a network, information related to the predicted action to a provider of the content item.

15. The non-transitory computer-readable storage medium of claim 13, wherein the classifier operates at least one of a one-sided entropy objective, a Shannon entropy objective and a Naïve Bayes (NB) entropy objective.

16. The non-transitory computer-readable storage medium of claim 13, further comprising operating the classifier using a Naïve Bayes (NB) entropy objective, the execution of the NB entropy objective causing the user data to be scaled by an order of magnitude, wherein the LR model is applied to the scaled user data.

17. The non-transitory computer-readable storage medium of claim 13, further comprising:
determining, based on the execution of the initializer, a cluster of cohort data, wherein the execution of the LR model is based on the cluster of cohort data.

18. A computing device comprising:
a processor configured to:
identify user data related to a content item, the user data being an aggregation of data from interactions with the content item by a cohort of users, the user data comprising information related to a label for each interaction;
execute a classifier as an initializer on the identified user data;
determine, based on the execution of the initializer, a set of user data clusters, each cluster corresponding to a feature of a user from the cohort;
execute a logistic regression (LR) model on the set of user data clusters; and
determine, based on the execution of the LR model, a predicted action by a user respective to the content item.

19. The computing device of claim 18, further comprising:
communicate, over a network, information related to the predicted action to a provider of the content item.

20. The computing device of claim 18, wherein the classifier operates at least one of a one-sided entropy objective, a Shannon entropy objective and a Naïve Bayes (NB) entropy objective, wherein the execution of the NB entropy objective causes the user data to be scaled by an order of magnitude, wherein the LR model is applied to the scaled user data.
